(19) United States
(12) Patent Application Publication
(10) Pub. No.: US 2015/0262088 A1
(43) Pub. Date: Sep. 17, 2015

(54) INTELLIGENT TICKET SUGGESTION ENGINE

(71) Applicant: Cubic Corporation, San Diego, CA (US)

(72) Inventor: Gavin Ritchie Smith, Crawley (GB)

(73) Assignee: Cubic Corporation, San Diego, CA (US)

(21) Appl. No.: 14/658,639

(22) Filed: Mar. 16, 2015

Related U.S. Application Data
(60) Provisional application No. 61/953,638, filed on Mar. 14, 2014.

(51) Int. Cl. G06Q 10/02; G06Q 50/30; G06Q 30/06

(52) U.S. Cl. CPC G06Q 10/02; G06Q 30/06; G06Q 50/30

(57) ABSTRACT

A method for providing intelligent ticket suggestions using a transaction device for transit fare purchases includes receiving an input from a fare media. The input includes an identifier associated with a user of the fare media. The input is communicated to a data store to identify a usage history and a purchase history for the user of the fare media. The usage history and purchase history are associated with the user of the fare media based on the identifier. The usage history and the purchase history for the user are received from the data store and a geographically closest transit stop relative to the transaction device is determined. Transit timetables and transit products available for purchase based on the geographically closest transit stop are identified. Transit product suggestions are generated based on one or more of the usage history, purchase history, transit timetables, or transit fares available for purchase.

### CROSS-REFERENCES TO RELATED APPLICATIONS

This Application claims priority to U.S. Provisional Patent Application No. 61/953,638 filed Mar. 14, 2015, entitled “INTELLIGENT TICKET SUGGESTION ENGINE,” the entire disclosure of which is hereby incorporated by reference, for all purposes, as if fully set forth herein.

### BACKGROUND OF THE INVENTION

Transit systems often offer a large number of transit products for sale. Such products may include single-ride tickets, multiple-ride tickets, monthly passes, and the like. The transit products may be associated with specific transit stops, and may include products for access at certain times and dates. Transit products may also include specific seat reservations and fare levels. Conventional transit vending machines allow users to browse, search, and purchase from a database of most or all of the available transit products. Due to the vast number of transit products available, this can result in time consuming, complex, and/or cumbersome interfaces. This can create long lines and frustrating user experiences for users of the vending machines.

### BRIEF SUMMARY OF THE INVENTION

In one aspect, a method for providing intelligent ticket suggestions using a transaction device for transit fare purchases is provided. The method may include receiving, using the transaction device, an input from a fare media. The input may include an identifier associated with a user of the fare media. The method may also include communicating the input to a data store such that a usage history and a purchase history for the user of the fare media may be identified. The usage history and purchase history may be associated with the user of the fare media based on the identifier of the input. The method may further include receiving the usage history and the purchase history for the user of the fare media from the data store and determining a geographically closest transit stop relative to the transaction device. The method may include identifying transit timetables and transit products available for purchase based on the geographically closest transit stop. The method may also include generating one or more transit product suggestions based on one or more of the usage history, the purchase history, the transit timetables, or the transit fares available for purchase.

In another aspect, a non-transitory computer-readable medium having instructions embedded thereon for providing intelligent ticket suggestions using a transaction device for transit fare purchases is provided. The instructions may include computer code for causing a computing device to receive, using the transaction device, an input from a fare media. The input may include an identifier associated with a user of the fare media. The instructions may also include computer code for causing a computing device to communicate the input to a data store such that a usage history and a purchase history for the user of the fare media may be identified. The usage history and purchase history may be associated with the user of the fare media based on the identifier of the input. The instructions may further include computer code for causing a computing device to receive the usage history and the purchase history for the user of the fare media from the data store and to determine a geographically closest transit stop relative to the transaction device. The instructions may include computer code for causing a computing device to identify transit timetables and transit products available for purchase based on the geographically closest transit stop. The instructions may also include computer code for causing a computing device to generate one or more transit product suggestions based on one or more of the usage history, the purchase history, the transit timetables, or the transit fares available for purchase.

In another aspect, a transaction device for transit purchases for providing intelligent ticket suggestions is provided. The transaction device may include a communications interface configured to send and receive data, a memory, and a processor. The processor may be configured to receive, using the transaction device, an input from a fare media. The input may include an identifier associated with a user of the fare media. The processor may also be configured to communicate the input to a data store such that a usage history and a purchase history for the user of the fare media may be identified. The usage history and purchase history may be associated with the user of the fare media based on the identifier of the input. The processor may further be configured to receive the usage history and the purchase history for the user of the fare media from the data store and to determine a geographically closest transit stop relative to the transaction device. The processor may be configured to identify transit timetables and transit products available for purchase based on the geographically closest transit stop. The processor may also be configured to generate one or more transit product suggestions based on one or more of the usage history, the purchase history, the transit timetables, or the transit fares available for purchase.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a system diagram showing a system for providing intelligent transit product suggestions according to embodiments.

FIG. 2 depicts a process for providing intelligent transit product suggestions according to embodiments.

FIG. 3 depicts a process for providing intelligent transit product suggestions according to embodiments.

FIG. 4 depicts a process for providing intelligent transit product suggestions according to embodiments.

FIG. 5 is a block diagram of an example computing system according to embodiments.

### DETAILED DESCRIPTION OF THE INVENTION

For the purposes of explanation, the ensuing description provides specific details that are set forth in order to provide a thorough understanding of various embodiments. It will be apparent, however, to one skilled in the art that various embodiments may be practiced without some of these specific details. For example, circuits, systems, networks, processes, and other components may be shown as components in block diagram form in order not to obscure the embodiments in unnecessary detail. In other instances, known circuits, processes, algorithms, structures, and techniques may be shown without unnecessary detail in order to avoid obscuring the embodiments. In other instances, well-known structures and devices are shown in block diagram form.

Embodiments provide intelligent transit product suggestions using transaction devices and/or retail environments. The suggestions are provided in the form of one or more transit products that a particular user may wish to purchase. The suggestions may be based on various factors, such as the user's purchase and usage history or popular trips. These suggestions may be provided to a user upon identification of the user such that any suggestions are tailored to the past behavior of each user. Oftentimes, a user is then able to locate and purchase a relevant transit product much more efficiently than using conventional transit product vending machine. For example, if a fare media is detected that has only ever been loaded with off-peak, standard class, adult tickets, a suggestion may be made including tickets matching this profile, rather than making a user sort through a large number of ticket options that have not been relevant to the user in the past. For first-time users, suggestions may be provided based on what products are generally popular and/or which products are popular to users of a similar demographic group as the first-time user.

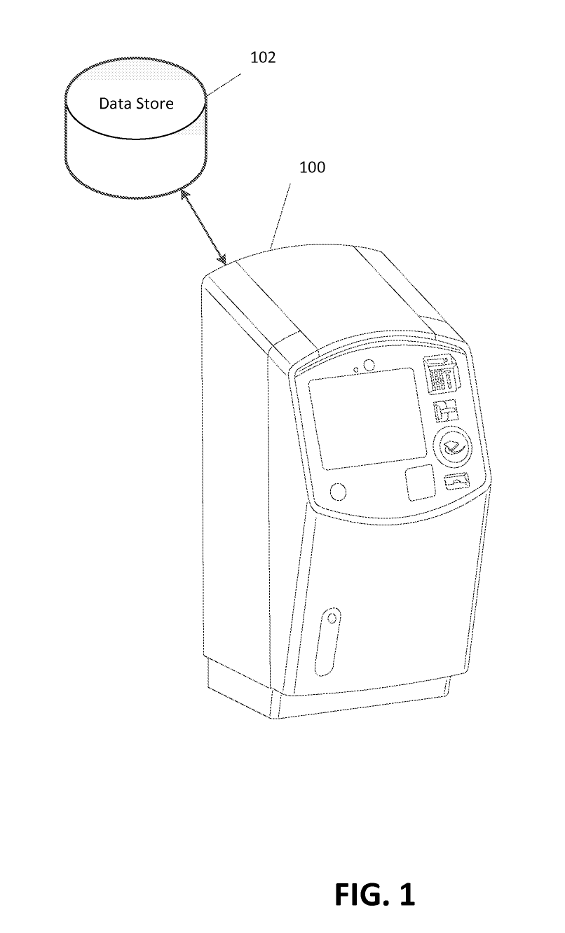

FIG. 1 depicts one embodiment of a transaction device 100 in communication with a data store 102 for use in systems for providing intelligent transit product suggestions. Transaction device 100 may be a vending machine, such as a Video Ticketing Office, a mobile device, or other computing device. For example, transaction device 100 may be a vending machine positioned near a transit stop and may include software and hardware to enable the selection and purchase of transit products. Mobile devices and computing devices accessing websites and/or running applications and other retail environments connected to a transit system computer or data store may be utilized as transaction device 100.

The transaction device 100 may be configured to receive an input. For example, a transit media, such as a smart card, mobile device, ticket, or other fare media may be read by the transaction device 100. The input may include some form of identification used to associate a user of the fare media with an account, such as an account within the transit system. For example, an alphanumeric identifier associated with an account may be received from the fare media. The input, along with the identifier, may be communicated to data store 102, where the identifier may be used to locate a usage and/or purchase history associated with the user, such as by accessing a transit account or history associated with the fare media. In some embodiments, such as those where transaction device 100 is a vending machine positioned near a transit stop, the data store 102 may be part of transaction device. In other embodiments, the data store 102 may be located remotely from the transaction device. The usage and/or purchase history may be communicated to the transaction device 100. In some embodiments, data store 102 may be separate from a vending machine, such as when data stores are part of a central transit server configured to receive purchase and usage data from a number of transaction devices and/or access control points of a transit system.

The transaction device 100 may determine a geographically closest transit stop. In some embodiments, the transaction device 100 may have a closest transit stop programed within the device, such as a vending machine near a transit stop that is used as a transaction device 100. In other embodiments, the transaction device 100 may include location sensors, such as global positioning satellite (GPS) sensors. Data from the GPS sensors may be compared to locations of transit stops to determine a closest transit stop. The locations of transit stops may be stored on transaction device 100, retrieved from data store 102, and/or accessed using a website and/or software application. The transaction device 100 may identify transit timetables and/or transit products available for purchase at the closest transit stop. This information, along with the usage history and/or the purchase history, may be used to generate transit product suggestions. The generation of transit product suggestions will be discussed in more detail below. These suggestions may be displayed on the transaction device 100 to provide a much quicker, efficient transit product purchase experience. For example, a display of the transaction device 100 may provide a list of suggested transit products based on the user's history, sales history of the transaction device 100, sales history associated with the transit stop, and/or based on timetables and available products at the transit stop. The transaction device 100 may include an override feature such that a user may bypass the suggestions and instead search and/or browse a list of categories and/or all available transit products. This allows users looking to purchase new and/or uncommon fares to still access transit products that were not suggested initially.

An origin and/or a destination may be selected. The transaction device 100 may include local information related to transit timetables and transit products available to purchase. In embodiments, such as those where the transaction device 100 is a mobile device or computing device, this information may be downloaded to the device and/or the information may be stored on a remote data store 102. In embodiments where transaction device 100 is a vending machine near a transit stop, the transit timetables, transit products available for purchase at that transit stop, and/or sales data at that transaction device 100 may be stored locally on the transaction device 100.

It will be appreciated that while represented as a single data store 102, multiple data stores may be used in conjunction with systems and methods for providing intelligent transit product suggestions. The multiple data stores may be part of a single entity, such as a central transit server, or may be spread among multiple systems and devices.

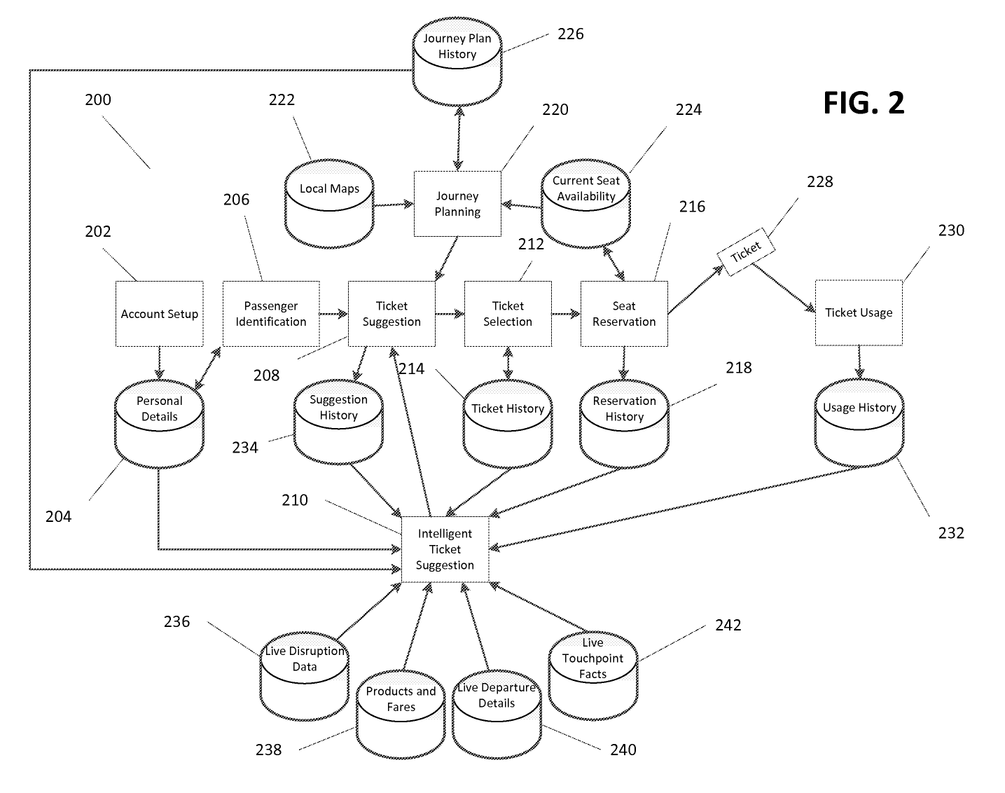

FIG. 2 depicts a process 200 of incorporating various data to create transit product suggestions. While shown as separate data stores, it will be appreciated that the data stores may be combined and/or separated in any manner. The data stores may be located on one or more devices. For example, some or all of the data stores may be located on a transaction device, such as transaction device 100 described above. Some or all of the data stores may be located remotely, such as on a central transit server. The data stores may be communicatively coupled with a transaction device such that data may be communicated between the data stores and the transaction device.

Process 200 may include setting up an account, such as a transit account, at 202. Information, such as demographic information, identifying information, and the like may be stored in a personal details data store 204 and associated with the transit account. A passenger may then utilize a transaction device to select and purchase transit products. An input is received that includes passenger information, such as an identifier associated with the transit account, at 206. The identifier may be used to retrieve personal details from the personal details data store 204, as well as to allow for the personal details to be updated. Upon identification of the user, one or more ticket suggestions may be provided at 208. The ticket suggestions may be provided by an intelligent suggestion engine 210.

In some embodiments, the ticket suggestion may occur after a journey is planned at 220. Journey planning may include receiving origin and/or destination information. Origin information may be received as an input from a user and/or may be based on the geographically closest transit stop. A user may select a destination, such as by entering a destination identifier, address, and/or by selecting a destination from a list of possible destinations. In some embodiments, a map of a transit system may be provided to the user from local map data store 222 using the transaction device such that a user may select an origin and/or destination. Current available seats and/or products may be retrieved from an available seat data store 224. A journey plan history data store 226 may be accessed to retrieve previous journeys to help a user select and plan a journey. In some embodiments, the intelligent suggestion engine 210 may be part of the transaction device, and may include a processor that takes information from the data stores to generate intelligent suggestions based on programmed logic. The intelligent suggestion engine 210 may receive information from a number of data stores to provide transit product suggestions to the identified user. A user may then select one or more transit products to purchase at 212. The purchases may include one or more transit products that have been suggested and/or transit products that a user searches and/or browses for from a database of available transit products. The transit product selection may be stored in a purchase history data store 214. In some embodiments, the process 200 may include receiving a selection for a seat reservation at 216. Seat reservations may be for particular seats and/or fare levels. For example, a user may select a first class ticket after first choosing an origin and destination. Seat reservation information may be stored in a reservation history data store 218. A fare media 228 may have the purchased transit products written onto it and/or a transit account associated with the fare media 228 may be credited with the transit products. The fare media 228 may then be used to gain access to a transit system, and the usage of the transit products may be stored within a usage history data store 232 at 230.

The intelligent suggestion engine 210 may utilize much of the information generated from previous transit product purchases and/or usage of transit products. For example, the intelligent ticket engine 210 may utilize information from personal details data store 204 to provide suggestions based on what transit products users having similar demographic profiles have previously purchased. This is especially useful for first-time transit users who do not have a purchase or usage history. In some embodiments, information from a suggestion history database 234 that is populated by based on previous product suggestions may be used by the intelligent suggestion engine 210 to provide repeat suggestions. This is particularly useful where purchase history of the user shows that the user has previously purchased one or more products previously provided as suggestions. The intelligent suggestion engine 210 may also incorporate data from journey plan history data store 226 to make suggestions based on a user's interactions that do not necessarily result in the purchase of a transit product. For example, a user may plan a trip that includes an origin, destination, preferred transit vehicle, time of day, day of week, and/or other information. The user may stop using the transaction device without making a purchase. This data may be logged and used for generating suggestions during subsequent uses of the transaction device.

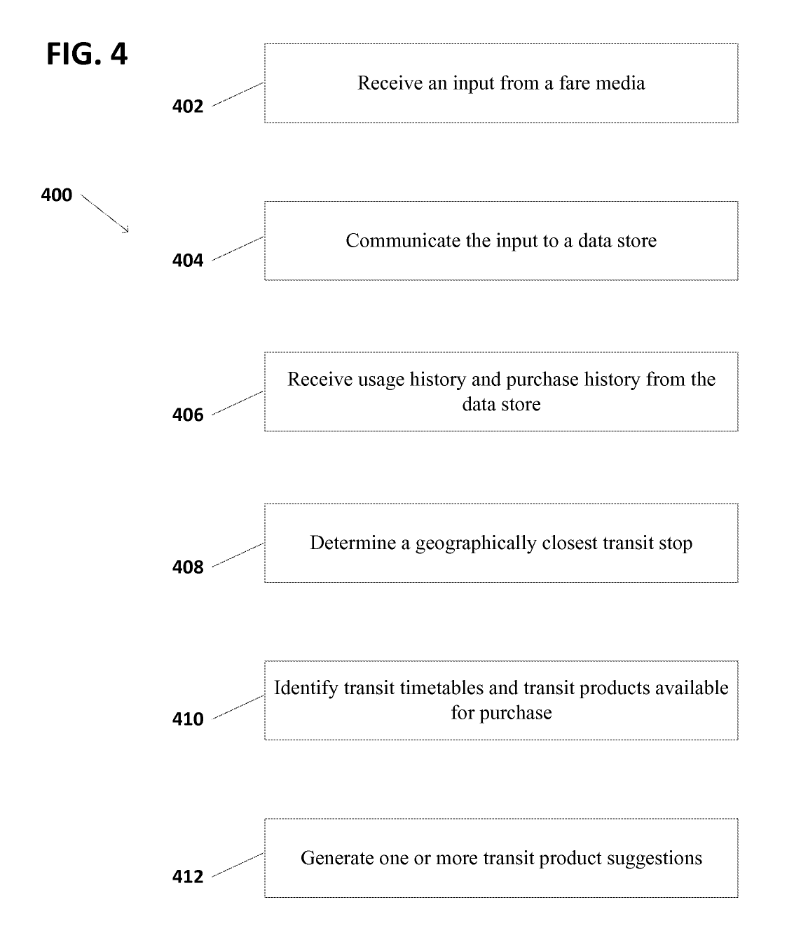

The intelligent suggestion engine 210 may also take into account the ticket history of a user account and/or fare media as stored within the ticket history data store 214. This enables the intelligent suggestion engine 210 to provide suggestions based on previous transit product purchases made by the user. Information from the reservation history data store 218 may be used to generate suggestions based on fare levels and/or seat preferences of a user. For example, a user who has often purchased first class window tickets may receive a suggestion for a similar transit product. The usage history of a transit product and/or fare media may be provided to the intelligent suggestion engine 210 from the usage history data store 228. The usage history may be used to provide more relevant and/or cheaper alternatives to transit products previously purchased by a user. For example, the intelligent suggestion engine 210 may determine that a user's cost per ride was excessive based on underutilization of a particular transit product. This information may be used to provide a cheaper product or more useful product and/or to determine whether a discount and/or rebate may be provided to the user, such as described in relation to process 400 of FIG. 4. The usage history information may also be used to identify transit products that a user often uses and may continually want to purchase.

Additional data stores may be used to generate intelligent transit product suggestions. For example, a live disruption data store 236 may include information related to transit delays, detours, and/or outages that may be used to provide transit product suggestions. For example, when combined with purchase and/or usage history the live disruption data may be used to generate alternative transit products that will get the user to common destinations in the event of transit system disruptions. Information from a products and fares data store 238 may be used to determine products available for purchase from which the intelligent suggestion engine 210 may select when generating product suggestions. Information from a live departure detail data store 240 may be used to identify transit vehicles that are due to leave soon, or otherwise access departure times. The departure data may be used to suggest transit products for vehicles that are leaving from the geographically closest transit stop in a short period of time. For example, a user may provide an identifier to a transaction device upon reaching a transit stop. The intelligent suggestion engine 210 may then provide a list of suggestions that includes transit products for vehicles departing in the next 20 minutes or other relevant timeframe. Information related to the particular transaction device may also be retrieved from a live touchpoint facts data store 242. Such data may include actual transit departure times, which may be based on live vehicle running data and/or traffic updates. The data may also include information related to a time of day, recent sales conducted on the transaction device, weather conditions, and/or other information that may be tracked and stored on the transaction device. Oftentimes, this data includes information about the device itself, real-time events, and/or environmental data. Different types of transaction devices may store different information in a live touchpoint facts data store 242. For example, a mobile device may be able to determine a current direction of travel, and therefore intelligent suggestion engine 210 may use this information to suggest transit journeys headed in a same or similar direction.

It will be appreciated that intelligent transit product suggestions may include suggestions from all, or a subset of the data stores and data types as described above. In some embodiments, a user's interactions with the transaction device may be logged, such as by logging keystrokes and/or screen touches. This information may be retrieved and analyzed by the intelligent suggestion engine 210 to help generate suggestions based on interactions beyond just completed purchases and other transactions. Product suggestions may also be based on factors not listed above. In some embodiments, the logic used to generate product suggestions may combine various data to form more intelligent suggestions. For example, usage and purchase data may be analyzed along with live disruption and departure details to provide suggestions to a user for an earliest departing transit product for a destination commonly traveled to by a user.

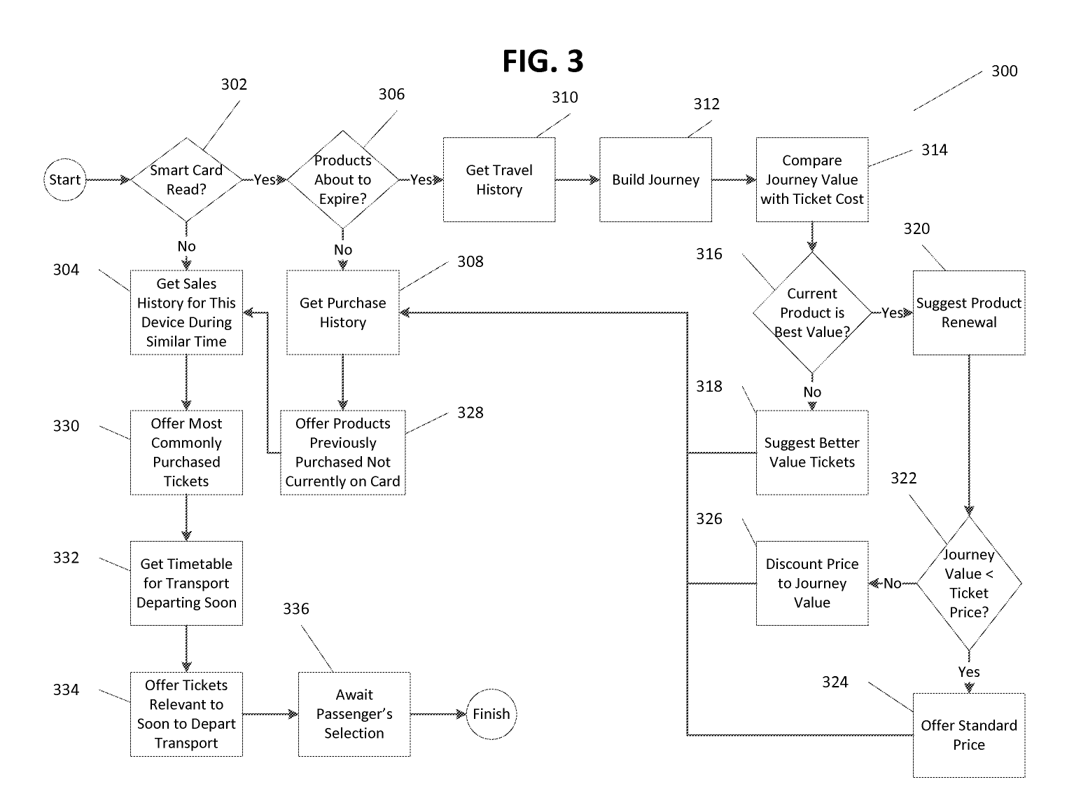

FIG. 3 depicts one embodiment of a process 300 for providing transit product suggestions. The process 300 may begin by determining whether a smart card or other fare media has been read at 302. Information may be read from the fare media, such as a smart card or mobile device, and may include an identifier of the fare media or of a transit account associated with the fare media. If a fare media was not read, sales history may be obtained for the transaction device during a similar time, day of week, and/or date at 304. This may occur, for example, if a user without an existing transit fare media uses the transaction device. Without a purchase and/or usage history, the transaction device may provide suggestions based on popular fares that have been purchased using the particular transaction device. If a fare media has been read, a determination as to whether the fare media or account includes any transit products that are about to expire or have recently expired at 306. An expiration threshold including a date or duration validity range may be set to determine which, if any products, qualify as about to expire. If no transit products on the fare media are about to expire, a purchase history of the fare media and/or transit account may be obtained at 308 such that suggestions may be made based on the purchase history. If a product is about to expire, travel history may be obtained for the user of the fare media at 310 based on the expired or about to expire transit product.

At 312, a journey, including a fare type, an origin, and a destination, may be built based on the travel history of the about to expire transit product. The value of the journey may then be compared to a price of the ticket at 314. A determination of whether the previously purchased product is a best value may be made at 316. If the previously purchased product is not the best value, a better value ticket may be suggested at 318. This determination may be based, for example, on a user's usage of the about to expire transit product. The purchase history of the transit account and/or fare media may then be obtained at 308 If the previously purchased product is the best value, a suggestion to renew the about to expire product may be made at 320. A determination may be made whether the journey value for the renewal product is less than the price of the product at 322. If the product value is greater than the price, the standard price may be offered at 324. If the product value is less than the price, the price may be discounted down to the journey value at 326. After the price is offered, the purchase history of the fare media and/or transit account may be obtained at 308. Products that have been previously purchased by the user, but are not currently on the card and/or the transit account may be offered as suggested transit products at 328. The sales history for the device during a similar time, date, and/or day of the week may then be obtained at 304. Based on this data, most commonly purchased tickets from the transaction device may be identified and provided as suggested transit products at 330.

Timetables for transit vehicles leaving a transit station near the transportation device may be obtained at 332. From the timetables, transit vehicles leaving soon, such as within 15 minutes of the user beginning to use the transaction device, may be identified. Transit products relevant to the soon leaving transit vehicles may be provided as suggestions at 334. The process 300 may end by awaiting a selection of one or more transit products at 336. The suggested transit products may include other types of product suggestions, such as those disclosed in relation to processes 200 and 400 described herein. In some embodiments, the selected transit product may be one not suggested, and instead a product that was located by the user by searching and/or browsing a database of transit products.

FIG. 4 depicts a process 400 for providing real-time location-based advertising within a transit system. Process 400 may be performed by a transaction device, such as a mobile device, vending machine, or other computing device, such as transaction device 100 of FIG. 1. At block 402, the process 400 may include receiving an input from a fare media. The input may include an identifier associated with a user of the fare media. For example the identifier may include the user's name, an account number associated with the user, and/or other identifying information. The input may be received by a user entering identification information into a screen of the transaction device, by reading data from a transit media, and/or by receiving biometric information associated with the user. At block 404, the input may be communicated to a data store such that a usage history and a purchase history for the user of the fare media may be identified. The data store may be local to the transaction device, or may be remotely located, such as on a central server. The identifier received at block 402 may be used to locate a user account having a usage and purchase history. The usage history and the purchase history for the user of the fare media may be communicated from the data store to the transaction device.

A geographically closest transit stop relative to the transaction device may be determined at block 406. In some embodiments, such as those where the transaction device is a vending machine located near a transit stop, determining the geographically closest transit stop may be done by accessing information stored on the transaction device. In other embodiments, such as those where a user's mobile device is used as the transaction device, the geographically closest transit stop may be detected by comparing a location of the mobile device to locations of transit stops stored on the mobile device or accessible by the mobile device. For example, location information from a GPS sensor of the mobile device may be compared to coordinates or other location information of transit stops that are accessed by the mobile device when running a mobile transit application. The transaction device may identify transit timetables and transit products available for purchase based on the geographically closest transit stop at block 408. One or more transit product suggestions may then be provided at block 410. The transit suggestions may be based on the usage history of the user and/or fare media, the purchase history of the user, the transit timetables, and/or the transit fares available for purchase. In some embodiments, one or more transit product suggestions may be provided on a display of the transaction device. For example, a list including several transit products provided from at least one of the categories above may be provided on an initial screen of the transaction device upon the identification of the user. The transit product suggestions may include a most popular transit product of the retail environment, a transit product associated with a soon departing transit vehicle from the geographically closest transit stop, a best value transit product, a recently expired transit product, and/or a previously purchased transit product.

In some embodiments, generating transit product suggestions may include identifying a best value transit product for a transit fare product based on the usage history of the user. The transit product suggestions may then include the best value transit product. Generating transit product suggestions may also include retrieving a transaction history for transactions at the geographically closest transit stop based on a date, a day of a week, a time, and/or a location. The transaction device may then identify popular and/or most commonly purchased transit products that match the date, the day of the week, the time, and/or the location. The popular transit products may then be provided as suggestions. This may be particularly useful for first-time users who have no purchase or usage history. In some embodiments, the suggestions may be provided in various orders, such as by popularity, value, cost, soonest departing, and/or any other criteria of sorting.

In some embodiments, the process 400 may include identifying a previously purchased transit product and analyzing the usage history of that previously purchased transit product. The transaction device may then determine that the previously purchased transit product was underutilized and offer a discounted transit product renewal. In some embodiments, rather than a discounted renewal, the transaction device may credit an account associated with the user to make up for any underutilization of a transit product. The process 400 may also provide suggestions based on transit products that are expired and/or recently expired. The transaction device may read data from the fare media and/or a transit account of the user to identify transit products currently on the fare media as well as those products that have expired. Products within an expiration threshold may be identified. The expiration threshold can be set to include already expired products and/or products about to expire. For example, an expiration threshold may include all transit products that have expired in the last two weeks and all transit products that are set to expire in the next week. In this manner, products that a user is likely to want to renew based on purchase and/or usage history may be identified. The transit products within this expiration threshold may be provided as transit product suggestions. It will be appreciated that other expiration thresholds may be used, including those that only include already expired products or those including only products nearing expiration.

The process 400 may further include receiving an override command, such as an input from a transaction device that instructs bypasses the suggestions. A display may then be provided that allows all available transit products to be accessed, such as by searching or browsing a database of transit products.

It will be appreciated that features of processes 200, 300, and 400 may be interchangeable, omitted, and/or additional features added. The processes may be carried out by a transaction device, such as transaction device 100 in communication with one or more data stores.

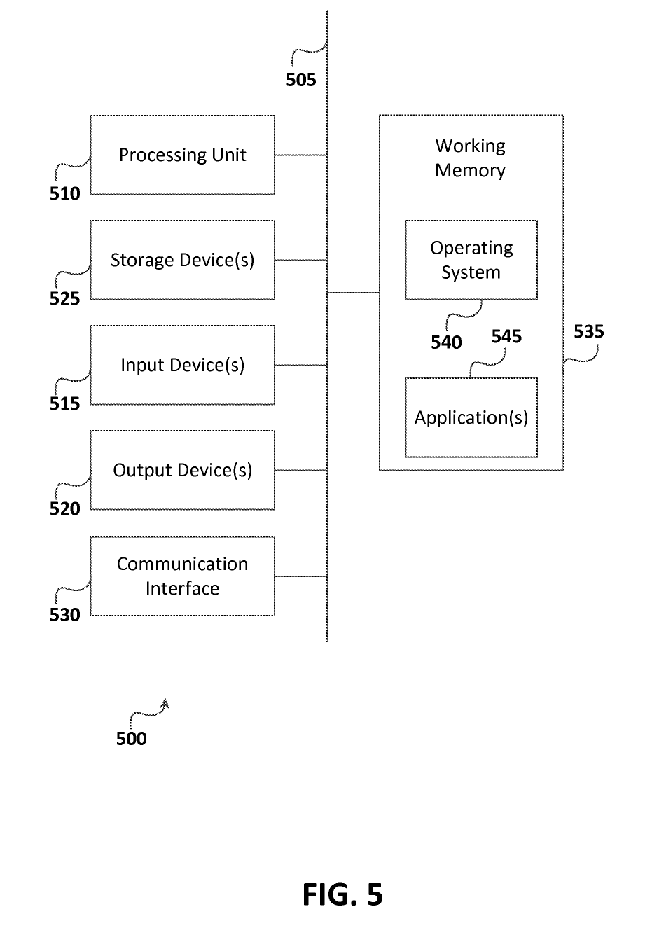

A computer system as illustrated in FIG. 5 may be incorporated as part of the previously described computerized devices. For example, computer system 500 can represent some of the components of the transaction device 100 and data store 102 of FIG. 1, as well as the transit servers described herein. FIG. 5 provides a schematic illustration of one embodiment of a computer system 500 that can perform the methods provided by various other embodiments, as described herein, and/or can function as the host computer system, a remote kiosk/terminal, a point-of-sale device, a mobile device, and/or a computer system. FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 505 (or may otherwise be in communication, as appropriate). The hardware elements may include a processing unit 510, including without limitation one or more general-purpose processors and/or one or more special-purpose processors (such as digital signal processing chips, graphics acceleration processors, and/or the like); one or more input devices 515, which can include without limitation a mouse, a keyboard, a touchscreen, receiver, a motion sensor, a camera, a smartcard reader, a contactless media reader, and/or the like; and one or more output devices 520, which can include without limitation a display device, a speaker, a printer, a writing module, and/or the like.

The computer system 500 may further include (and/or be in communication with) one or more non-transitory storage devices 525, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 500 might also include a communication interface 530, which can include without limitation a modem, a network card (wireless or wired), an infrared communication device, a wireless communication device and/or chipset (such as a Bluetooth™ device, an 502.11 device, a WiFi device, a WiMax device, an NFC device, cellular communication facilities, etc.), and/or similar communication interfaces. The communication interface 530 may permit data to be exchanged with a network (such as the network described below, to name one example), other computer systems, and/or any other devices described herein. In many embodiments, the computer system 500 will further comprise a non-transitory working memory 535, which can include a RAM or ROM device, as described above.

The computer system 500 also can comprise software elements, shown as being currently located within the working memory 535, including an operating system 540, device drivers, executable libraries, and/or other code, such as one or more application programs 545, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 525 described above. In some cases, the storage medium might be incorporated within a computer system, such as computer system 500. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, a risk management engine configured to provide some or all of the features described herein relating to the risk profiling and/or distribution can comprise hardware and/or software that is specialized (e.g., an application-specific integrated circuit (ASIC), a software method, etc.) or generic (e.g., processing unit 510, applications 545, etc.) Further, connection to other computing devices such as network input/output devices may be employed.

Some embodiments may employ a computer system (such as the computer system 500) to perform methods in accordance with the disclosure. For example, some or all of the procedures of the described methods may be performed by the computer system 500 in response to processing unit 510 executing one or more sequences of one or more instructions (which might be incorporated into the operating system 540 and/or other code, such as an application program 545) contained in the working memory 535. Such instructions may be read into the working memory 535 from another computer-readable medium, such as one or more of the storage device(s) 525. Merely by way of example, execution of the sequences of instructions contained in the working memory 535 might cause the processing unit 510 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 500, various computer-readable media might be involved in providing instructions/code to processing unit 510 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 525. Volatile media include, without limitation, dynamic memory, such as the working memory 535. Transmission media include, without limitation, coaxial cables, copper wire and fiber optics, including the wires that comprise the bus 505, as well as the various components of the communication interface 530 (and/or the media by which the communication interface 530 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a magnetic medium, optical medium, or any other physical medium with patterns of holes, a RAM, a PROM, EPROM, a FLASH-EPROM, any other memory chip or cartridge, a carrier wave as described hereinafter, or any other medium from which a computer can read instructions and/or code.

The communication interface 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a non-transitory storage device 525 either before or after execution by the processing unit 510.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

May include data from just interaction with kiosk, even if no purchase is made (keystroke monitoring)

What is claimed is:

1. A method for providing intelligent ticket suggestions using a transaction device for transit fare purchases, the method comprising:
receiving, using the transaction device, an input from a fare media, the input comprising an identifier associated with a user of the fare media;
communicating the input to a data store such that a usage history and a purchase history for the user of the fare media may be identified, wherein the usage history and purchase history are associated with the user of the fare media based on the identifier of the input;
receiving the usage history and the purchase history for the user of the fare media from the data store;
determining a geographically closest transit stop relative to the transaction device;
identifying transit timetables and transit products available for purchase based on the geographically closest transit stop; and
generating one or more transit product suggestions based on one or more of the usage history, the purchase history, the transit timetables, or the transit fares available for purchase.

2. The method for providing intelligent ticket suggestions using a transaction device for transit fare purchases according to claim 1, further comprising:
identifying a best value transit product for a transit fare product based on the usage history of the user, and wherein the one or more transit product suggestions comprises the best value transit product.

3. The method for providing intelligent ticket suggestions using a transaction device for transit fare purchases according to claim 1, wherein:
the one or more transit product suggestions comprises one or more of a most popular transit product of the retail environment, a transit product associated with a soon departing transit vehicle from the geographically closest transit stop, a best value transit product, a recently expired transit product, or a previously purchased transit product.

4. The method for providing intelligent ticket suggestions using a transaction device for transit fare purchases according to claim 1, further comprising:
identifying a previously purchased transit product;
determining that the previously purchased transit product was underutilized; and
offering a discounted transit product renewal.

5. The method for providing intelligent ticket suggestions using a transaction device for transit fare purchases according to claim 1, further comprising:
receiving an override command; and
providing a display, based on the reception of the override command, such that all available transit products may be accessed.

6. The method for providing intelligent ticket suggestions using a transaction device for transit fare purchases according to claim 1, further comprising:
retrieving a transaction history for transactions at the geographically closest transit stop based on one or more of a date, a day of a week, a time, or a location, wherein the one or more transit product suggestions comprises a popular transit ticket matching the one or more of the date, the day of the week, the time, or the location.

7. The method for providing intelligent ticket suggestions using a transaction device for transit fare purchases according to claim 1, further comprising:
detecting one or more transit products associated with the fare media; and
determining that at least of the one or more transit products is within an expiration threshold, wherein the one or more transit product suggestions comprises a renewal of the one or more transit products within the expiration threshold.

8. A non-transitory computer-readable medium having instructions embedded thereon for providing intelligent ticket suggestions using a transaction device for transit fare purchases, the instructions comprising computer code for causing a computing device to:
receive, using the transaction device, an input from a fare media, the input comprising an identifier associated with a user of the fare media;
communicate the input to a data store such that a usage history and a purchase history for the user of the fare media may be identified, wherein the usage history and purchase history are associated with the user of the fare media based on the identifier of the input;
receive the usage history and the purchase history for the user of the fare media from the data store;
determine a geographically closest transit stop relative to the transaction device;
identify transit timetables and transit products available for purchase based on the geographically closest transit stop; and
generate one or more transit product suggestions based on one or more of the usage history, the purchase history, the transit timetables, or the transit fares available for purchase.

9. The non-transitory computer-readable medium of claim 8, further comprising instructions for causing the computing device to:
identify a best value transit product for a transit fare product based on the usage history of the user, and wherein the one or more transit product suggestions comprises the best value transit product.

10. The non-transitory computer-readable medium of claim 8, wherein:
the one or more transit product suggestions comprises one or more of a most popular transit product of the retail environment, a transit product associated with a soon departing transit vehicle from the geographically closest transit stop, a best value transit product, a recently expired transit product, or a previously purchased transit product.

11. The non-transitory computer-readable medium of claim 8, further comprising instructions for causing the computing device to:
identify a previously purchased transit product;
determine that the previously purchased transit product was underutilized; and
offer a discounted transit product renewal.

12. The non-transitory computer-readable medium of claim 8, further comprising instructions for causing the computing device to:
receive an override command; and
provide a display, based on the reception of the override command, such that all available transit products may be accessed.

13. The non-transitory computer-readable medium of claim 8, further comprising instructions for causing the computing device to:
retrieve a transaction history for transactions at the geographically closest transit stop based on one or more of a date, a day of a week, a time, or a location, wherein the one or more transit product suggestions comprises a popular transit ticket matching the one or more of the date, the day of the week, the time, or the location.

14. The non-transitory computer-readable medium of claim 8, further comprising instructions for causing the computing device to:
detect one or more transit products associated with the fare media; and
determine that at least of the one or more transit products is within an expiration threshold, wherein the one or more transit product suggestions comprises a renewal of the one or more transit products within the expiration threshold.

15. A transaction device for transit purchases for providing intelligent ticket suggestions, comprising:
a communications interface configured to send and receive data;
a memory; and
a processor configured to:
receive, using the transaction device, an input from a fare media, the input comprising an identifier associated with a user of the fare media;
communicate the input to a data store such that a usage history and a purchase history for the user of the fare media may be identified, wherein the usage history and purchase history are associated with the user of the fare media based on the identifier of the input;
receive the usage history and the purchase history for the user of the fare media from the data store;
determine a geographically closest transit stop relative to the transaction device;
identify transit timetables and transit products available for purchase based on the geographically closest transit stop; and
generate one or more transit product suggestions based on one or more of the usage history, the purchase history, the transit timetables, or the transit fares available for purchase.

16. The transaction device for transit purchases for providing intelligent ticket suggestions of claim 15, wherein the processor is further configured to:
identify a best value transit product for a transit fare product based on the usage history of the user, and wherein the one or more transit product suggestions comprises the best value transit product.

17. The transaction device for transit purchases for providing intelligent ticket suggestions of claim 15, wherein:
the one or more transit product suggestions comprises one or more of a most popular transit product of the retail environment, a transit product associated with a soon departing transit vehicle from the geographically closest transit stop, a best value transit product, a recently expired transit product, or a previously purchased transit product.

18. The transaction device for transit purchases for providing intelligent ticket suggestions of claim 15, further comprising:
a user interface configured to receive an override command, and wherein the processor is further configured to provide a display, based on the reception of the override command, such that all available transit products may be accessed.

19. The transaction device for transit purchases for providing intelligent ticket suggestions of claim 15, wherein the processor is further configured to:
retrieve a transaction history for transactions at the geographically closest transit stop based on one or more of a date, a day of a week, a time, or a location, wherein the one or more transit product suggestions comprises a popular transit ticket matching the one or more of the date, the day of the week, the time, or the location.

20. The transaction device for transit purchases for providing intelligent ticket suggestions of claim 15, wherein the processor is further configured to:
detect one or more transit products associated with the fare media; and
determine that at least of the one or more transit products is within an expiration threshold, wherein the one or more transit product suggestions comprises a renewal of the one or more transit products within the expiration threshold.
